(19) United States
(12) Patent Application Publication
(10) Pub. No.: US 2014/0082128 A1
(43) Pub. Date: Mar. 20, 2014

(54) DYNAMIC DETECTION AND SELECTION OF FILE SERVERS IN A CACHING APPLICATION OR SYSTEM

(71) Applicant: NetApp, Inc., Sunnyvale, CA (US)

(72) Inventor: Derek Beard, Austin, TX (US)

(73) Assignee: NetApp, Inc., Sunnyvale, CA (US)

(21) Appl. No.: 14/031,018

(22) Filed: Sep. 18, 2013

Related U.S. Application Data
(60) Provisional application No. 61/702,687, filed on Sep. 18, 2012.

(51) Int. Cl. H04L 29/08

(52) U.S. Cl. CPC H04L 29/08549
USPC 709/216

(57) ABSTRACT

A cache system includes one or more network attached storage (NAS) caching appliances for managing a network topology of the enterprise network, in which the cache system dynamically probes the enterprise network to build a topology map of the accessible network devices.

### RELATED APPLICATIONS

This patent application claims benefit of priority to Provisional U.S. Patent Application No. 61/702,687; the aforementioned priority application being hereby incorporated by reference in its entirety for all purposes.

### TECHNICAL FIELD

Examples described herein relate to dynamic detection and selection of file servers in a caching application or system.

### BACKGROUND

Data storage technology over the years has evolved from a direct attached storage model (DAS) to using remote computer storage models, such as Network Attached Storage (NAS) and a Storage Area Network (SAN). With the direct storage model, the storage is directly attached to the workstations and application servers, but this creates numerous difficulties with the administration, backup, compliance and maintenance of the directly stored data. These difficulties are alleviated at least in part by separating the application server/workstations from the storage medium. For example, FIG. 1 depicts a typical NAS system 100 in which a number of PCs, workstations and application servers (clients) use a network 10 to access storage resources on a number of remote network attached storage and file servers (or filers). In the depicted system 100, each of the networked PC or workstation devices 12-14 and application servers 16-18 may act as a storage client that is connected to the network 10 by the appropriate routers 11 and switches 15 to remotely store and retrieve data with one or more NAS filers 1-6, which in turn are connected to the network 10 by the appropriate routers 9 and switches 7-8. Typically, the storage clients (e.g., 14) use an IP-based network protocol, such as CIFS and NFS, to communicate store, retrieve and modify files on an NAS filer (e.g., 5).

Conventional NAS devices are designed with data storage hardware components (including a plurality of hard disk drives, one or more processors for controlling access to the disk drives, I/O controller and high speed cache memory) and operating system and other software that provides data storage and access functions. Even with a high speed internal cache memory, the access response time for NAS devices continues to be outpaced by the faster processor speeds in the client devices 12-14, 16-18, especially where anyone NAS device may be connected to a plurality of clients. In part, this performance problem is caused by the lower cache hit rates that result from a combination of larger and constantly changing active data sets and large number of clients mounting the NAS storage device.

### BRIEF DESCRIPTION OF THE DRAWINGS

FIG. 1 depicts a prior art NAS system.

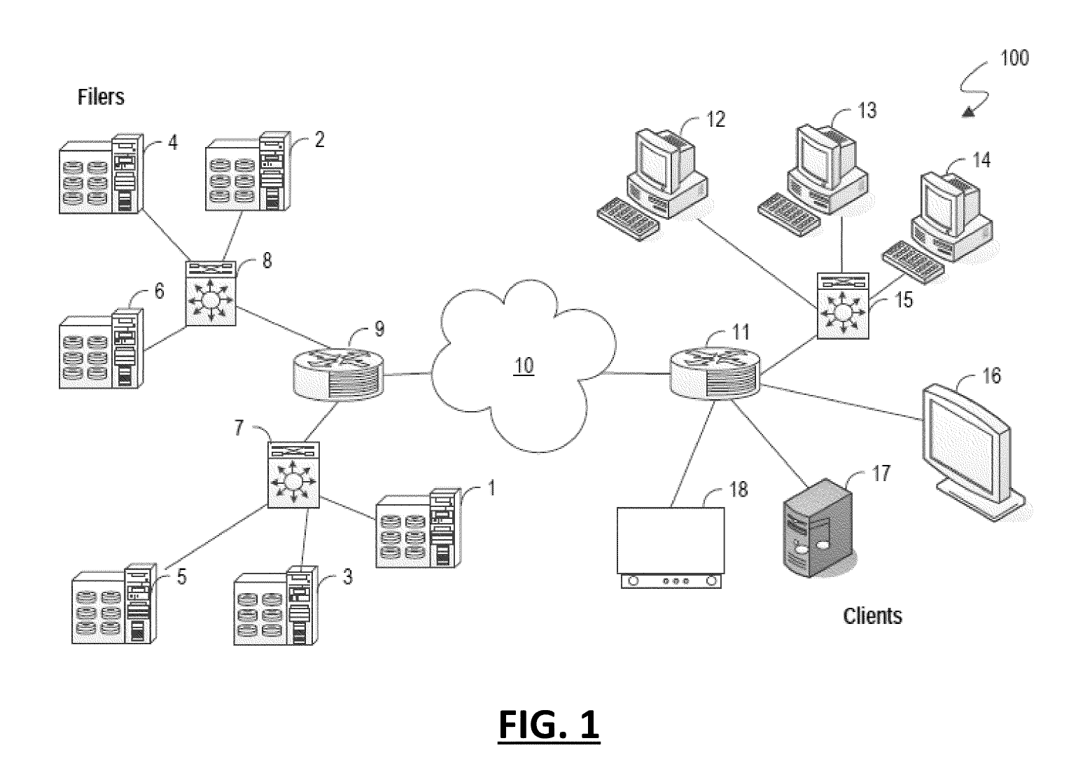

FIG. 2 illustrates an example of a networked system that utilizes intelligent, cache appliances, including topology detection logic, according to an embodiment.

FIG. 3 illustrates an example of a cache system for use with a system such as described with FIG. 2.

FIG. 4 illustrates another example of a cache system for use with a system such as described with FIG. 2.

FIG. 5 illustrates another example of a cache cluster for use with a system such as described with FIG. 2.

FIG. 6 illustrates another example of a cache system for use with a system such as described with FIG. 2.

FIG. 7 illustrates a NAS cache appliance, in accordance with one or more embodiments.

FIG. 8 illustrates an example process flow for managing a network topology at a standalone in-line cache appliance.

### DETAILED DESCRIPTION

Examples described herein include a cache system for a networked file system. In some embodiments, the cache system includes one or more network attached storage (NAS) caching appliances for managing a network topology of the enterprise network, in which the cache system dynamically probes the enterprise network to build a topology map of the accessible network devices.

In some embodiments, a cache system includes a network topology manager that operates to ensure that each cache appliance responds to NAS protocol traffic only where safe and appropriate by actively maintaining an accurate list or topology map of the active filers in its network segment. In addition, a computer program product is disclosed that includes a non-transitory computer readable storage medium having computer readable program code embodied therein with instructions which are adapted to be executed to implement a method for operating a NAS caching appliance, substantially as described hereinabove.

Among other benefits, a high-performance network attached storage (NAS) caching appliance can be provided for a networked file system to deliver enhanced performance to I/O intensive applications, while relieving overburdened storage subsystems. The examples described herein identify the active data sets of the networked system and use predetermined policies to control what data gets cached using a combination of DRAM and SSDs to improve performance, including guaranteeing the best performance for the most important applications. Examples described herein can further be positioned between the storage clients and the NAS filers, to intercept requests between the clients and filers, and to provide read and write cache acceleration by storing and recalling frequently used information. In some embodiments, a cache system that includes NAS caching appliance manages the network topology in which it is connected by dynamically probing the network to build a topology map of all accessible network devices. Using the topology map, the NAS cache appliances respond only when it is correct to do so, thus protecting against frame flooding while enabling minimal customer configuration.

In selected embodiments, the operations described herein may be implemented using, among other components, one or more processors that run one or more software programs or modules embodied in circuitry and/or non-transitory storage media device(s) (e.g., RAM, ROM, flash memory, etc.) to communicate to receive and/or send data and messages. Thus, it will be appreciated by one skilled in the art that the present invention may be embodied in whole or in part as a method, system, or computer program product. For example, a computer-usable medium embodying computer program code may be used, where the computer program code comprises computer executable instructions configured to provide dynamically detect and select file servers associated with a requested caching operation. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

It should be understood that as used herein, terms such as coupled, connected, electrically connected, in signal communication, and the like may include direct connections between components, indirect connections between components, or both, as would be apparent in the overall context of a particular embodiment. The term coupled is intended to include, but not be limited to, a direct electrical connection.

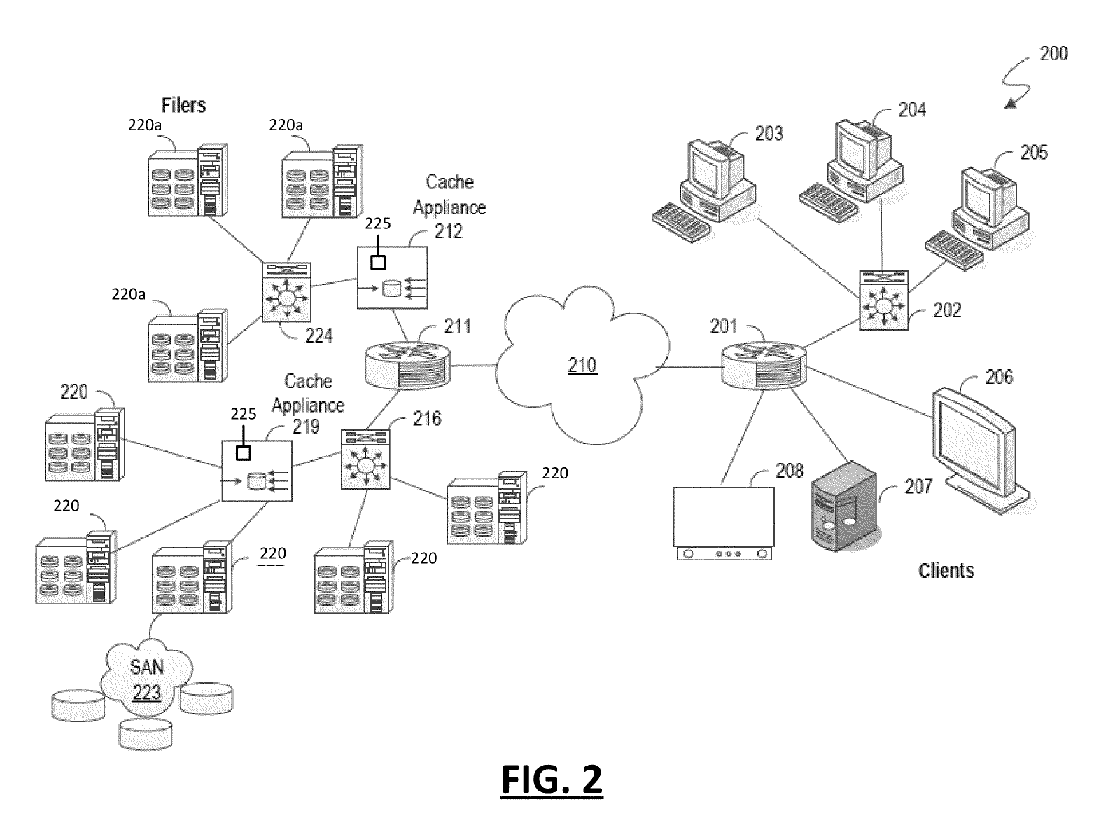

FIG. 2 illustrates an example of a networked system that utilizes intelligent, cache appliances, including topology detection logic, according to an embodiment. In an example of FIG. 2, an enterprise network system 200 includes multiple file system servers 220 and file system server groups 220a that collectively operate as one or more NAS filers of the enterprise file system 200. The system 200 includes one or more cache appliances 212, 219 located in front of a file system server 220 and/or file system server groups 220a. One or more clients 203-205 or 206-208 connect to and utilize the enterprise file system 200. In the example provided, clients 203-205 correspond to, for example, mobile or desktop PCs or workstations, and clients 206-208 correspond to application servers (collectively termed “clients 203-208”). Each of the clients 203-208 may run a separate application which requires access to remotely-stored application data. In operation, a requesting client sends a read or write request over the network 210 using the appropriate routers 201, 211 and/or switches 202, 216, 224. Such requests may be directed to the destination NAS filer using an appropriate IP-based network protocol, such as, for example, CIFS or NFS.

According to examples described herein, the cache appliances 212, 219 are disposed logically and/or physically between at least some clients 203-208 and the file system server 220 and/or filer server groups 220a of the NAS filer. In more detail the cache appliances 212, 219 include intelligent cache appliances which are installed in-line between individual clients 203-208 and the destination NAS filer. The individual clients 203-208 issue requests for a respective NAS filer provided with the system 200. Such requests can include read or write requests in which file system objects of the respective NAS filer is used. More specifically, examples described herein provide for the cache appliances 212, 219 to (i) store a segment of the data of the NAS filer, and (ii) process requests from the clients 203-208 directed to the NAS filer. The cache appliances 212, 219 can each include programmatic resources to optimize the handling of requests from the clients 203-208 in a manner that is transparent to the clients 203-208. In particular, the cache appliances 212, 219 can respond to individual client requests, including (i) returning up-to-date but cached application data from file system objects identified from the client requests, and/or (ii) queuing and then forwarding, onto the NAS filer, write, modify or create operations (which affect the NAS filer), and subsequently updating the contents of the respective cache appliances 212, 219. In general, the cache appliances 212, 219 enable the individual client requests to be processed more quickly than would otherwise occur if the client requests were processed from the disk arrays or internal cache memory of the file system servers. More generally, the cache appliances 212, 219 can be positioned in-line to cache the NAS filer without requiring the clients 203-208 to unmount from the NAS filer.

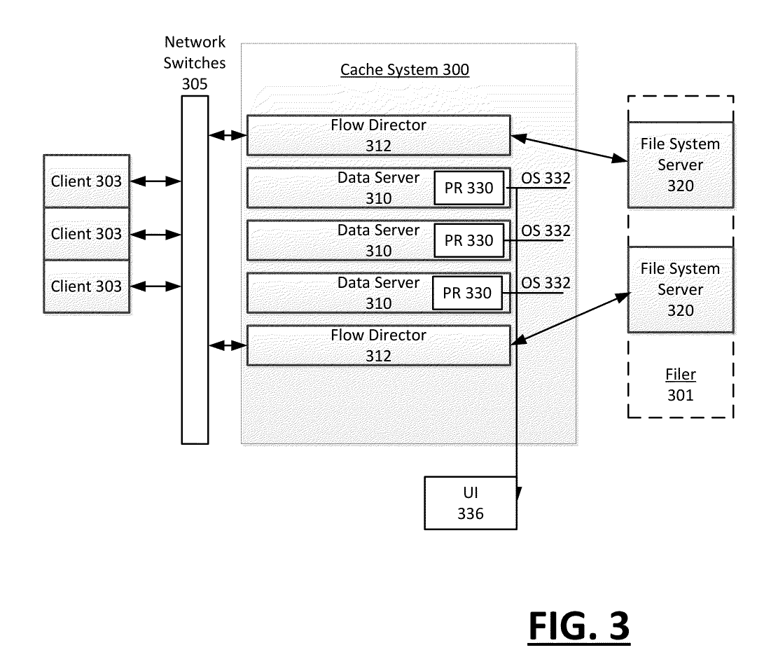

In an example of FIG. 2, each cache appliance 212, 219 can include one or more cache appliances that are connected together and working in tandem to form a single homogeneous caching device. Examples of cache appliances 212, 219 are provided with embodiments described with FIG. 3 through FIG. 6, as well as elsewhere in this application. Furthermore, in an example of FIG. 2, each cache appliance 212, 219 can include an appliance that is constructed as a high-speed packet processor with a substantial cache memory. For example, each cache appliance 212, 219 can correspond to an appliance that includes a set of network processing resources (such as a network switch and network processor(s)), a dynamic cache memory, a non-volatile cache memory and/or cache controller(s). The processing resources of the individual cache appliances 212, 219 can be configured to handle, for example, NFS type requests from the clients 203-208.

As further shown by an example of FIG. 2, individual cache appliances 212, 219, can be installed in multiple different locations of the system 200. In this manner, the individual cache appliances 212, 219 provide caching resources for one or more NAS filers, as shown by the placement of the cache appliance 219 in relation to file servers 220, or alternatively, to a group of NAS filers as shown by the placement of the cache appliance 212 in relation to the NAS filers provided by the file servers 220 and file server groups 220a. However positioned, the cache appliances 212, 219 each operate to intercept requests between the clients and the servers 220. In this way, the cache appliances 212, 219 are able to provide read and write cache acceleration by storing and recalling frequently used information. In some embodiments, the cache appliances 212, 219 are positioned as part of a required path between a respective file server and some or all of the clients. In particular, the cache appliances 212, 219 are positioned to intercept traffic directed from clients 203-208 to a particular file server 220 or set of file servers 220a in order to avoid cache coherency problems. In particular, cache coherency problems can arise when a piece of information stored with cache appliance 212, 219 is modified through an alternate path.

As described with some examples, each cache appliance 212, 219 can be provided with packet inspection functionality. In this way, each cache appliance 212, 219 are able to inspect the information of each of the intercepted packets in each of the TCP/IP stack layers. Through packet inspection, cache appliances 212, 219 can determine (i) the physical port information for the sender and receiver from the Layer 2 (data link layer), (ii) the logical port information for the sender and receiver from the Layer 3 (network layer), (iii) the TCP/UDP protocol connection information from the Layer 4 (transport layer), and (iv) the NSF/CIFS storage protocol information from the Layer 5 (session layer). Additionally, some embodiments provide that the cache appliances 212, 219 can perform packet inspection to parse and extract the fields from the upper layers (e.g., Layer 5-Layer 7). Still further, some embodiments provide that the packet inspection capability enables each cache appliance 212, 219 to be spliced seamlessly into the network so that it is transparent to the Layer 3 and Layer 4 layers.

According to embodiments, the cache appliances 212, 219 can accelerate responses to storage requests made from the clients. In particular, the packet inspection capability enables each cache appliance 212, 219 to be spliced seamlessly into the network so that it is transparent to the Layer 3 and Layer 4 layers and only impacts the storage requests by processing them for the purposes of accelerating them, i.e., as a bump-in-the-wire. Rather than splicing all of the connection parameters in the Layer 2, Layer 3 and Layer 4, some embodiments provide that each cache appliance 212, 219 can splice only the connection state, source sequence number and destination sequence number in Layer 4. By leaving unchanged the source and destination MAC addresses in the Layer 2, the source and destination IP addresses in the Layer 3 and the source and destination port numbers in the Layer 4, the cache appliances 212, 219 can generate a programmatic perception that a given client 203-208 is communicating with one of the NAS filers of the enterprise network system 200. As such, there is no awareness at either the clients 203-208 or file servers 220, 220a of any intervening cache appliance 212, 219. In this way, the cache appliances 212, 219 can be inserted seamlessly into an existing connection with the clients 203, 208 and the NAS filer(s) provided with the system 200, without requiring the clients to be unmounted. Additionally, among other benefits, the use of spliced connections in connecting the cache appliances 212, 219 to the file servers 220 and file server groups 220 enable much, if not all, of the data needs of the individual clients to be served from the cache, while providing periodic updates to meet the connection timeout protocol requirements of the file servers 220.

In more detail, the cache appliance 212, 219 can process a read or write request by making only Layer 1 and Layer 2 configuration changes during installation or deployment. As a result, no filer or client configuration changes are required in order to take advantage of the cache appliance. With this capability, an installed cache appliance 212, 219 (e.g., appliance) provides a relatively fast and transparent storage caching solution which allows the same connections to be maintained between clients and filers. As described with some embodiments, if there is a failure at the cache appliance 212, 219, the cache appliance automatically becomes a wire (e.g., pass through) between the client and filer who are able to communication directly without any reconfiguration.

According to some embodiments, cache appliance 212, 219 are implemented as a network attached storage (NAS) cache appliance, and connected as an in-line appliance or software that is positioned in the enterprise network system 200 to intercept requests to one or more of the file servers 220, or server groups 220a. This configuration provides clients 203-208 expedited access to the data within the requested files, so as to accelerate NAS storage performance. As an appliance, cache appliances 212, 219 can provide acceleration performance by storing the data of the NAS filers (provided from the file servers 220 and server groups 220a) in high-speed media. In some embodiments, cache appliances 212, 219 are transparently installed appliances, deployed between the clients 203-208 and file system servers 220, 220a without any network or reconfiguration of the endpoints. Without client or file server configuration changes, the cache appliances 212, 219 can operate intelligently to find the active dataset (or a designated dataset) of the NAS filers, and further to copy the active data sets into DRAM and SSD memory. The use of DRAM and SSD memory provides improvement over conventional type memory used by the file servers. For example, in contrast to conventional approaches, embodiments described herein enable cache appliances 212, 219 to (i) operate independently, (ii) operate in a manner that is self-contained, (iii) install in-line in the network path between the clients and file servers. Knowing the contents of each packet allows data exchanged with the file servers 220, 220a (e.g., NFS/CIFS data) to be prioritized optimally the first time the data is encountered by the cache appliances, rather than being moved after-the-fact.

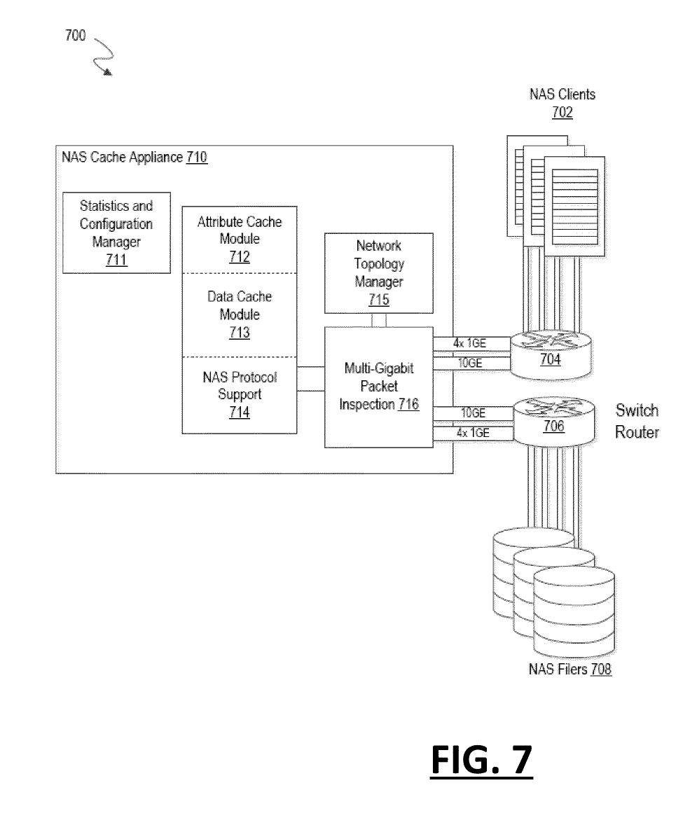

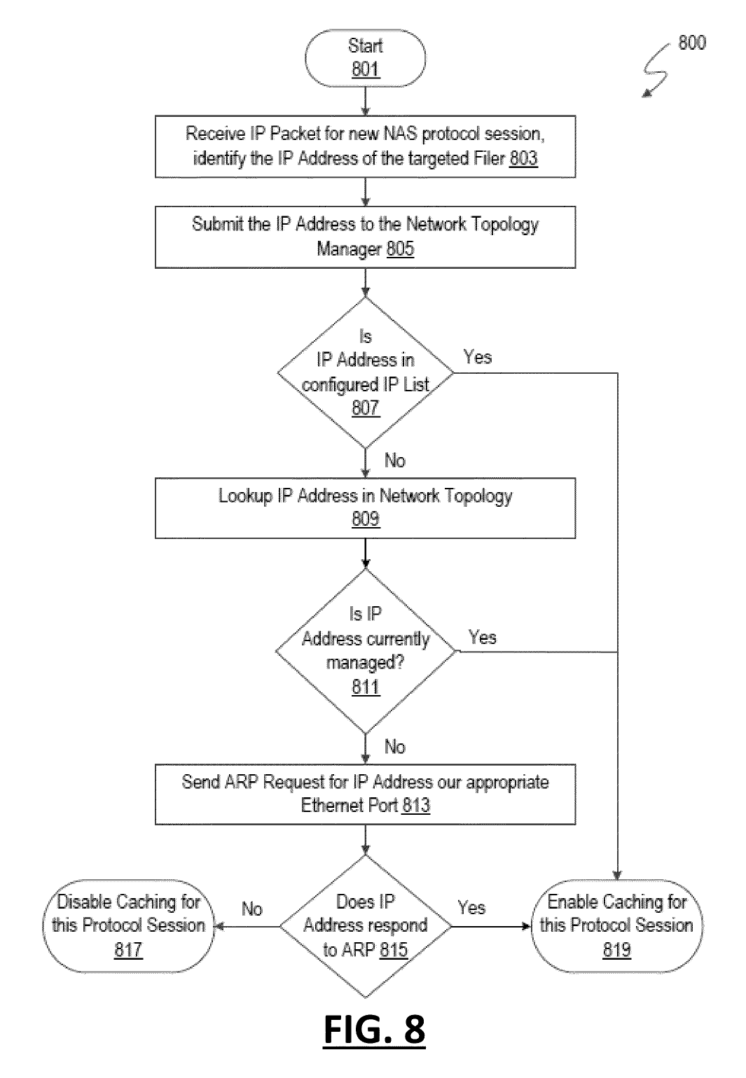

As described with an example of FIG. 7 and FIG. 8, each of cache appliance 212, 219 includes topology detection logic 225. The topology detection logic 225 can perform operations to detect the topology of. By detecting the topology of the system 200, the cache appliances 212, 219 can, for example, determine when client requests should be handled through cache resources, rather than passed to the networked file system for response.

FIG. 3 illustrates an example of a cache system for use with a system such as described with FIG. 2. In particular, FIG. 3 illustrates a cache system 300 that includes multiple data servers 310 and flow directors 312. In this way, the cache system 300 can include multiple appliances, including NAS cache appliances. The cache system 300 utilizes network switches 305 to connect to clients 303 across one or more networks. In implementation, the components of the cache system 300 (e.g., data servers 310, flow directors 312) can be positioned in-line with respect to clients 303 and file system servers 320 of a networked system 301. Accordingly, connectivity between the clients 303 and the cache system 300, as well as between the cache system 300 and the file system servers 320 of the networked system 301, can be across one or more networks. The networked system 301 can correspond to, for example, a combination of file system servers of the networked system, as described with an example of FIG. 2 (e.g., see network system 200 of FIG. 2).

According to one aspect, the cache system 300 includes one or more data servers 310, one or more flow directors 312, and processing resources 330. In some implementations, the processing resources 330 that coincide with resources of the data servers 310 implement a cache operating system 332. Additionally, the processing resources 330 can perform various analytic operations, including recording and/or calculating metrics pertinent to traffic flow and analysis.

In some embodiments, the data server 310 implements operations for packet-inspection, as well as NFS/CIFS caching. Multiple data servers 310 can exist as part of the cache system 300, and connect to the file servers 320 of the networked system 301 through the flow director(s) 312. The flow director(s) 312 can be included as active and/or redundant devices to interconnect the cache system 300, so as to provide client and file server network connectivity for filer 301.

The cache operating system 332 can synchronize the operation of the data servers 310 and flow directors 312. In some embodiments, the cache operating system 332 uses active heartbeats to detect node failure (e.g., failure of one of the data servers 310). If a node failure is detected, the cache operating system 332 removes the node from the cache system 300, then instructs remaining nodes to rebalance and redistribute file responsibilities. If a failure is detected from one of the flow directors 312, then another redundant flow director 312 is identified and used for redirected traffic.

In one implementation, a user interface 336 can be implemented through the processing resources 330. The user interface 336 can be implemented as, for example, a web-interface. The processing resources 330 can be used to gather and view statistics, particularly as part of the operations of the data server 310 and the flow director 312. The user interface 336 can be used to display metrics and statistics for purpose of, for example, troubleshooting storage network issues, and configuring the NAS cache system 300. For example, administrators can use the user interface 336 to view real-time information on cache performance, policy effectiveness, and application, client, and file server performance.

According to some embodiments, the data servers 310 include packet inspection and NFS/CIFS caching infrastructure for the cache system 300. In one implementation, the data servers 310 utilize multiple cache media to provide different performance levels. For example, in some embodiments, each data server 310 supports DDR3 DRAM and high performance SSD storage for caching. In operation, data servers 310 communicate with both clients 303 and file system servers 320, by, for example, inspecting every message and providing the information necessary to intelligently cache application data.

In some embodiments, the data servers 310 can be implemented in a manner that is extensible, so as to enable expansion and replacement of data servers 310 from the cache system 300. For example, each data server 310 can employ hot swappable power supplies, redundant fans, ECC memory and enterprise-level Solid State Disks (SSD).

Further, in some embodiments, the flow directors 312 operate as an enterprise-level Ethernet switch (e.g., 10 GB Ethernet switch). The flow directors 312 can further be implemented with software so as to sit invisibly between clients 303 and file system servers 320. In the cache system 300, the flow director 312 load balances the data severs 310. The individual flow directors 312 can also provide the ingress and egress point to the network. Additionally, the flow directors 312 can also filter traffic that passes through non-accelerated protocols. In some implementations, flow directors 312 work in concert with the operating system 332 to provide failover functionality that ensures access to the cached data is not interrupted.

In some embodiments, the flow directors 312 can also operate so that they do not participate in switching protocols between client and file server reciprocal ports. This allows protocols like Spanning Tree (STP) or VLAN Trunking Protocol (VTP) to pass through without interference. Each flow director 312 can work with the data servers 310 in order to support, for example, the use of one or more of Link Aggregation (LAG) protocols, 802.1Q VLAN tagging, and jumbo frames. Among other facets, the flow directors 312 can be equipped with hot swappable power supplies and redundant fans. Each flow director 312 can also be configured to provide active heartbeats to the data servers 310. In the event that one of the flow directors 312 becomes unresponsive, an internal hardware watchdog component can disable client/file server ports in order to facilitate failover on connected devices. The downed flow director 312 can then be directed to reload and can rejoin the cache system 300 if once again healthy.

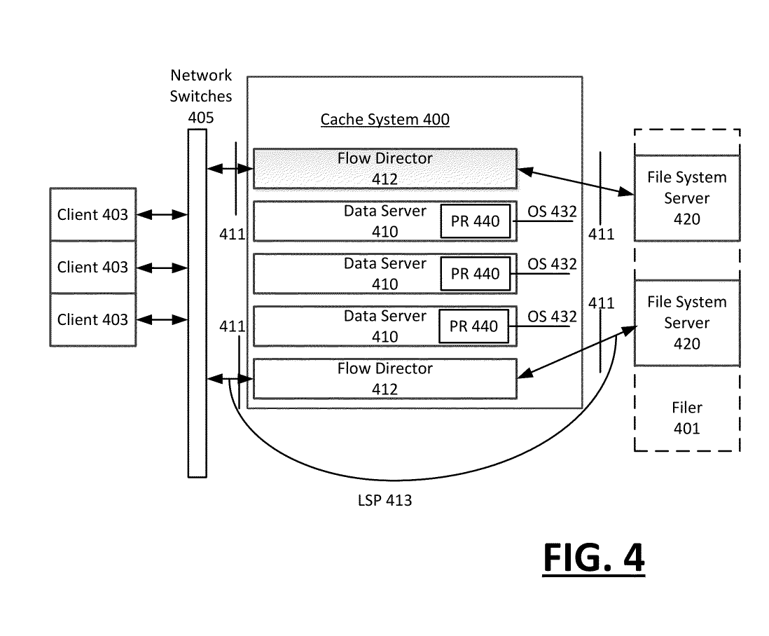

FIG. 4 illustrates another example of a cache system for use with a system such as described with FIG. 2. In particular, FIG. 4 illustrates a cache system 400 that includes multiple data servers 410, flow directors 412 and processing resources 430 on which an operating system 432 can be implemented. In this way, the cache system 300 can include multiple appliances, including NAS cache appliances. The cache system 400 utilizes network switches 405 to connect to clients 403 across one or more networks. In implementation, the cache system 400 can be positioned in-line with respect to clients 403 and file system servers 420 of a networked system 401. Accordingly, connectivity between the clients 403 and the cache system 400, as well as between the cache system 400 and the file system servers 420 of the networked system 401, can be across one or more networks. As with an example of FIG. 3, the networked system or filer 401 can correspond to, for example, a combination of file system servers 420 that provide one or more NAS filers, as described with an example of FIG. 2 (e.g., see system 200 of FIG. 2).

In an example of FIG. 4, the flow directors 412 and data server 410 support 802.1Q VLAN tagging connections 411 to the client-side switch and the file servers. The data servers 410 operate to maintain the connection state between the clients 403 and file servers 420 of the filer, so that network traffic can flow indiscriminately through either of the flow directors 412. In this way, the flow directors 412 are essentially equal bidirectional pathways to the same destination. As a result, any link failover is negotiated between the client switch and individual file servers, with the operating system 432 facilitating failover with Link State Propagation (LSP) communications 413 and link aggregation protocols. In this arrangement, the flow director(s) 412 provide an LSP feature for the in-line cache system 400 to maintain end-to-end link state between the client switch and file server. Since, in the example provided with FIG. 4, the flow director(s) 412 are physically located between these devices, these flow directors actively monitor reciprocal connections so both client-side and file server-side connections are in sync. This allows implementation of the LAG protocol (if employed) to dynamically adjust in case of link failure.

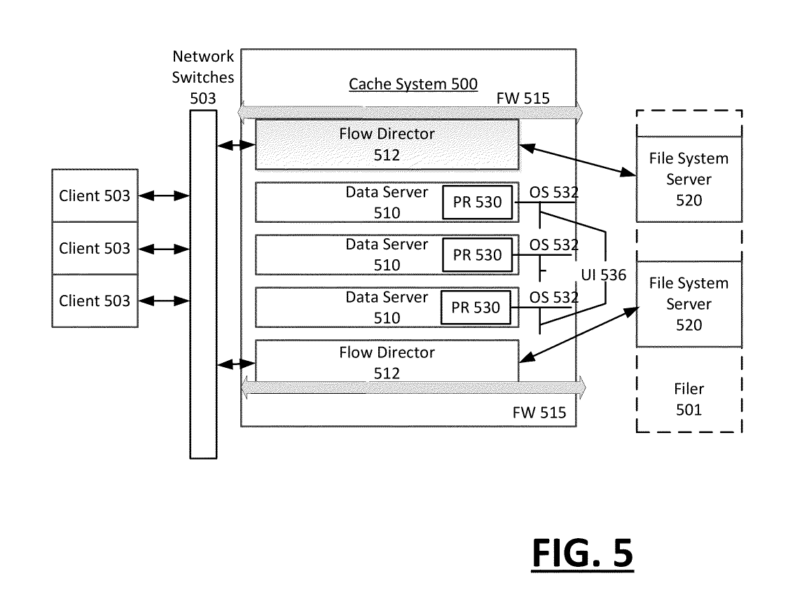

FIG. 5 illustrates another example of a cache cluster for use with a system such as described with FIG. 2. In an example of FIG. 5, an in-line NAS cache system 500 includes two (or more) flow directors 512, a supporting data server 510, and processing resources 530 on which an operating system 532 can be implemented. In this way, the cache system 500 can include multiple appliances, including NAS cache appliances. The cache system 500 utilizes network switches 505 to connect to clients 503 across one or more networks. In implementation, the cache system 500 can be positioned in-line with respect to clients 503 and file system servers 520 of a networked system 501. Accordingly, connectivity between the clients 503 and the cache system 500, as well as between the cache system 500 and the file system servers 520 of the networked system 501, can be across one or more networks. As with an example of FIG. 3, the networked system or filer 501 can correspond to, for example, a combination of file system servers 520 that provide one or more NAS filers, as described with an example of FIG. 2 (e.g., see system 200 of FIG. 2).

The data servers 510 can be connected between individual file system servers 520 and a client-side switch for some of the clients 503. As depicted, the flow directors 512 and data server 510 provide a fail-to-wire pass through connection 515. The connection 515 provides a protection feature for the in-line cache system 500 in the event that the data servers 510 fail to maintain heartbeat communications. With this feature, the flow director(s) 512 are configured to automatically bypass the data server(s) 510 of the cache system in case of system failure. When bypassing, the flow directors 512 send traffic directly to the file system servers 520. Using active heartbeats, the flow directors 512 can operate to be aware of node availability and redirect client requests to the file system server 520 when trouble is detected at the cache system.

A bypass mode can also be activated manually through, for example, a web-based user interface 536, which can be implemented by the processing resources 530 of the cache system 500. The active triggering of the bypass mode can be used to perform maintenance on data server nodes 510 without downtime. When the administrator is ready to reactivate the cache system 500, cached data is revalidated or flushed to start with a “clear cache” instruction.

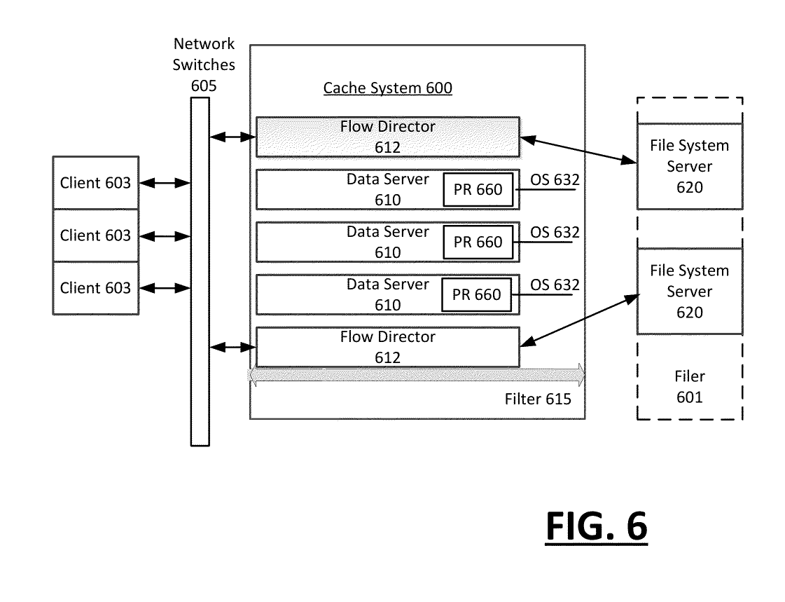

FIG. 6 illustrates another example of a cache system for use with a system such as described with FIG. 2. In an example of FIG. 6, an in-line cache system 600 includes two (or more) flow directors 612 and one or more supporting data servers 610. In this way, the cache system 600 can include multiple appliances, including NAS cache appliances. The cache system 600 utilizes network switches 605 to connect to clients 603 across one or more networks. The data server 610 can be connected between one of the file system servers 620 of the NAS filer 601 and clients 603 (including iSCSI clients). In implementation, the cache system 600 can be positioned in-line with respect to clients 603 and file system servers 620 of a networked system 601. Accordingly, connectivity between the clients 603 and the cache system 600, as well as between the cache system 600 and the file system servers 620 of the networked system 601, can be across one or more networks. As with an example of FIG. 3, the networked system or filer 601 can correspond to, for example, a combination of file system servers 620 that provide one or more NAS filers, as described with an example of FIG. 2 (e.g., see system 200 of FIG. 2).

As depicted, the flow directors 612 and data server 610 of the cache system 600 provide a low latency, wire-speed filtering feature 615 for the in-line cache system 600. With filtering feature 615, the flow director(s) 612 provide advanced, low-latency, wire-speed filtering such that the flow director filters only supported-protocol traffic to the system. Substantially all (e.g., 99%) other traffic is passed straight to the file system servers 620 of the NAS filer 601, thereby ensuring that the data servers 610 focus only on traffic that can be cached and accelerated.

In support of the various features and functions described herein, each cache system 600 implements operating system 632 (IQ OS) (e.g., FreeBSD) to be customized with a purpose built caching kernel. Operating across all data servers and interacting with flow directors in the cache system, the OS 632 serves basic functions that include network proxy, file object server, and generic storage access. As a network proxy between clients and file servers, the OS 632 performs Layer 2 topology discovery to establish what is physically connected. Once the topology is determined, it maintains the network state of all connections. As requests are intercepted, the requests are converted to NAS-vendor independent file operations, streamlining the process while allowing the cache system 600 to incorporate other network protocols in the future.

Once requests are converted, the cache appliance system 600 handles generic metadata operations, and data operations are mapped to virtual devices. Virtual devices can be implemented with DRAM, flash memory, and/or other media, and are categorized according to their performance metrics, including latency and bandwidth. Virtualization of devices allows the OS 632 to easily incorporate faster media to further improve performance or denser media to add cache capacity. Once the media hierarchy or tier is established within the cache resources of the system 600, blocks are promoted and demoted based on frequency of use, unless “pinned” to a specific tier by the administrator. Additionally, in some implementations, the data servers 610 can operate a policy engine, which can implement user-defined polices, and proactively monitor the tiers of cache and prioritize the eviction of data blocks.

In one implementation, the cache system 600 may include a DRAM virtual tier where metadata is stored for the fastest random I/O access. In the DRAM virtual tier, user-defined profiles can be “pinned” for guaranteed, consistent access to critical data. SWAP files, database files, and I/O intensive virtual machine files (VMDKs) are a few examples of when pinning data in DRAM can provide superior performance.

In addition or in the alternative, some implementations provide that each cache system 600 may include a virtual tier for Solid State Disks (SSD) which can be added at any time to expand cache capacity. To maximize performance and capacity, individual SSDs are treated as an independent virtual tier, without RAID employment. In the event of a failed SSD, the overall cache size will shrink only by the missing SSD. The previously cached data will be retrieved from the file server (as requested) and stored on available media per policy.

Using packet inspection functionality of the data server 610, the OS 632 at the cache system 600 learns the content of data streams, and at wire-speed, makes in-flight decisions based on default or user-defined policies to efficiently allocate high-performance resources where and when they are required most. Because data is initially stored to its assigned virtual tier, blocks are moved less frequently, which increases overall efficiency. However, as data demands change, the OS 632 also considers frequency of use to promote or demote blocks between tiers (or evict them completely out of cache).

In support of the caching operations, each cache system 600 can include one or more default built-in policies which assign all metadata to the highest tier (currently DRAM) and all other data to a secondary pool with equal weight. Frequency of use will dictate if data is to be migrated between tiers. And with no user-defined profiles enabled, the default policy can control caching operations. In addition, one or more file policies may be specified using filenames, file extensions, file size, file server, and file system ID (FSID) in any combination with optional exclusions. An example file policy would be to “cache all *.dbf files less that 2 GB from file server 192.168.2.88 and exclude file201.dbf.” Client policies may also use IP addresses or DNS names with optional exclusions to specify cache operations. An example client policy would be to “cache all clients in IP range: 192.168.2.0/24 and exclude 192.168.2.31”

As will be appreciated, one or more cache policy modifiers may be specified, such as a “quota” modifier which imposes a limit on the amount of cache a policy consumes and can be specified by size or percent of overall cache. Quota modifiers can be particularly useful in multitenant storage environments to prevent one group from over-consuming resources. In addition, a “schedule” modifier may be used to define when a policy is to be activated or disabled based on a time schedule. An example, the cache system 600 can activate the “Nightly Software Build” profile at 9 pm and disable at 6 am. Another policy modifier referenced above is a user-created exception to “pin” data to a particular tier or the entire cache. A pinned policy means other data cannot evict the pinned data—regardless of frequency of use. Such a policy can be useful for data that may not be accessed often, but is mission-critical when needed. In busy environments that do not support pinning, important but seldom used data will never be read from cache because soon after it is cached, the data is evicted before it is needed again. Pinned policies can address this unwanted turnover. Yet another modifier is a “Don't Cache” modifier which designates by file name of client request selected data that is not to be cached. This option can be useful when dealing with data that is only read once, not critical, or which may change often. As another example, a “priority” modifier may be used to manually dictate the relative importance of policies to ensure data is evicted in the proper order. This allows user-defined priorities to assign quality of service based on business needs.

Using the cache policies and modifiers, the cache behavior of the cache system 600 can be controlled to specify data eviction, migration, and multi-path support operations. For example, the cache system 600 can make an eviction decision based on cache priority from lowest to highest (no cache, default, low, high, and pin), starting with the lowest and moving to higher priority data only when the tier is full. In one implementation, eviction from cache resources of the cache system 600 can be based on priority, and then usage. For example, the lowest priority with the least accessed blocks will be evicted from cache first, and the highest priority, most used blocks will be evicted last.

The cache system 600 can also control the migration of data within the cache based strictly by usage, so that the most active data, without regard to priority, will migrate to the fastest cache tier. Likewise, as other data becomes more active, stale data will be demoted. Data pinned to a specified tier is excluded from migration.

In some implementations, the cache system 600 can also include a Mufti-Path Support (MPS) mechanism for validating the data in the cache resources of the cache system 600. With the MPS mechanism, the NAS cache checks backend file server attributes at a configurable, predefined interval (lease time). Data may change when snap-restoring, using multiprotocol volumes (i.e., CIFS, NFSv2/4), or if there are clients directly modifying data on the backend file server. When a client reads a file, MPS evaluates its cache lease time to determine whether it needs to check file server attributes. If not expired, the read will be served immediately from cache. If expired, MPS checks the backend file server to confirm no changes have occurred. If changes are found, MPS will pull the data from the file server, send it to the client, reset its lease, and update the cache. With regular activity, file leases should rarely expire since they are updated on most NFS operations. Expiration only occurs on idle files. MPS timeout can be configured from, for example, a minimum (e.g., 3 seconds) to a maximum (e.g., 24 hours).

FIG. 7 illustrates a NAS cache appliance system, in accordance with one or more embodiments. The NAS cache appliance system 710 can be implemented as part of a computer network 700 (e.g., enterprise network) in which network clients 702 access files and other file system objects of the network accessible file system (filer) 708.

In an example shown, the cache appliance system 710 includes a statistics and configuration manager 711, an attribute cache model 712, a data cache module 713, a protocol support component 714, a network topology manager 715 and a packet inspection engine 716. Among other functions, the network topology manager 715 dynamically detects resources (e.g., server) of the filer 708 that utilize the cache appliance 710.

The cache appliance system 710 can be deployed at a location in the network where it can monitor, and interact with, client communications that are intended for the filer 708. When a request to read or write application data is received from a storage client 702, the NAS cache appliance system 710 can use dedicated, high-speed packet inspection hardware 716 to inspect the packets of incoming requests to determine if they should be passed inward for further processing by the NAS cache appliance system 710 or forwarded to another destination, such as a NAS filer 708. For example, if the NAS client 702 requests application data that is stored on the NAS cache appliance system 710, the packet inspection hardware 716 may process the request based on I/O profiles to determine if the request is to be processed by the NAS cache system 710. If so, the request is passed internally to the tiered memory cache system. For example, Tier 1 storage is reserved for the most critical data (including email, high transaction databases, business critical processes and line of business applications), while Tier 0 storage refers to an in-band, network-resident, policy-driven, high-performance, scalable tier of memory subsystems that is used for the storage of business critical data under control of a policy engine that is managed independently from the one or more NAS filers. Within the tiered memory, a volatile or dynamic random access memory virtual tier may be used to store metadata and/or application data for the fastest random I/O access, while a non-volatile random access memory (NVRAM) provides a space for caching pending write operations to NAS filers for the purpose of maintaining data coherency in a failure event, such as network packets not arriving to their destination. If it is determined that the request cannot be serviced by the NAS cache appliance/cluster 710, the client request is sent to the destination NAS 708.

An issue with conventional network deployments is the dynamic nature of the network whereby network administrators have conventionally been required to add and remove filers to provide the correct storage access for their network. In addition, conventional approaches provide that an administrator manually configures a NAS cache appliance to enable the caching services for a new filer. In order to eliminate this requirement and provide an intelligent and efficient NAS acceleration appliance, a cache appliance or system is provided that dynamically detects network devices that are serving as filers on the network. Once detected, the files of the NAS filers can be cached, so that the clients have fast cache access to the files of the NAS filer, without requiring updated configuration. This is accomplished by adding the capability to manage the network topology from within the NAS cache appliance. While this mechanism is generally useful for detection and automatic configuration of Filer access when implemented in any deployed NAS cache systems, it can provide further enhancements when implemented within a Transparent NAS Cache. As a transparent NAS cache does not require configuration of file-system mount points, the use of a network topology manager within the cache allows for the detection of new filers added to the network and employing caching services for those filers without any configuration steps required on the cache appliance.

As described herein, a network topology manager 715 operates to ensure that the NAS cache appliance system 710 responds to NAS protocol traffic only where safe and appropriate. The NAS cache appliance system 710 proxies on behalf of NAS Filers 708 by responding to any NAS traffic received from a client 702. Dynamic detection of the filers 708 active in the network 700 is required for the internal caching software to maintain the list of network devices to proxy. The normal behavior of a network switch provides for circumstances in which packets may be forwarded (flooded) onto a network segment that are not relevant to any filer or host. Because of this issue, each NAS cache appliance system 710 maintains an accurate list of the active filers in its network segment.

Frame flooding refers to the condition that arises when an 802.1D compliant switch receives a frame destined for a MAC address (e.g., a 48-bit address that uniquely identifies a network interface) that does not exist in its Forwarding Database (FDB). In this situation, the switch will transmit the frame to all ports in the virtual local area network (VLAN) (e.g., an IEEE 802.1q VLAN), except for the ingress port. Due to this frame flooding behavior, a cache appliance can receive a NAS protocol packet for a valid Ethernet destination that is not currently deployed on any of the network ports that the cache appliance has access to. If the cache appliance were to respond to these flooded packets, the forwarding table in the switch would be updated incorrectly, potentially resulting in frames not arriving at the correct endpoint.

To address this, the network topology manager 715 dynamically probes the customer's networks to build a topology map of all network devices accessible by the NAS cache appliance system 710. That topology map is used to ensure the NAS cache appliance system 710 responds only when it is correct to do so, thus protecting against frame flooding while enabling minimal customer configuration. The network topology manager 715 must support a wide range of network deployments, including mufti-port LAGs, asymmetric ARP paths, and filer head failover.

In selected embodiments, the network topology manager 715 uses the Address Resolution Protocol (ARP) (IEEE RFC 826, 1042, and others) to determine what endpoints exist and additionally where each endpoint exists from the perspective of the NAS cache appliance 710, where ARP is a network protocol used to resolve a Layer 3 network address to a network hardware address. In typical IP networking, ARP is used to resolve an IP address to an Ethernet MAC address. Each identified endpoint is described by a MAC and IP address, and is represented by an endpoint entry in the NAS cache appliance 710. Each entry may include the endpoint identity the physical cache appliance network port and a customer VLAN ID associated with the endpoint. This 4-tuple (MAC, IP, port, customer VLAN ID) defines the endpoint entry within the network topology manager 715. Each endpoint entry is associated with a network segment. The network segment is represented by a segment entry. Each segment entry is associated with a unique broadcast domain on a given cache appliance network port. Each segment entry is identified by its cache appliance network port and customer 802.1q VLAN ID. Each segment entry contains a list of IP entries that reside on or are being discovered on this segment.

When the network topology manager 715 receives an ARP request or reply, it automatically creates an endpoint entry for the source of the ARP. In other words, the source endpoint of the ARP is considered to be authoritative and indicates that a real endpoint exists on the ingress cache appliance network port and customer VLAN.

Once an endpoint is created, the network topology manager 715 periodically probes it with an ARP request to determine if it still exists at the same location. If the endpoint fails to respond after some number of retries, the network topology manager 715 removes the endpoint from its topology map and notifies the network stack that all connections for the dead endpoint should be torn down.

When the network stack receives an NAS protocol packet for a new flow, it queries the network topology manager 715 to determine if the destination endpoint is valid for the egress cache appliance port. If the network topology manager 715 has an existing valid endpoint in the topology map, the network topology manager 715 indicates that the endpoint is valid and the network stack continues processing the received packet as expected. If the destination endpoint is not yet discovered, the network topology manager 715 starts the endpoint discovery process.

To validate that the endpoint is real, an ARP request is sent to the destination described by the 4-tuple from the triggering packet. The probe ARP will be created using source information in one of 3 ways:

Use the Configured Network Identity.

In the primary deployment mode, the Network Identity (NetID) is used if available within the network topology manager 715. As will be appreciated, the NetID is an administrator-configured valid IP address and Subnet used by the NAS cache appliance 710 to validate existence of filers. One NetID is required for each network segment. The network topology manager 715 takes the IP address of the endpoint that it is attempting to validate and performs a Radix lookup in order to find a configured NetID subnet that matches that IP. If one is found, then network topology manager 715 uses the NetID IP associated with that subnet entry as the source IP in the ARP request.

Using a Discovered Endpoint's Identity.

This is a fallback option if no valid NetID is available to use as the source IP address in ARP discovery. Since the network topology manager 715 engine always associates endpoints with a network segment, the network topology manager 715 will use a discovered endpoint on the partner segment if one exists.

Use the Source IP and MAC from the Triggering Packet.

If the network topology manager 715 is not configured with a NetID and does not have a previously discovered endpoint, it will ARP with the source IP and source MAC address from the packet that is triggering the endpoint discovery. This option works well when NAS clients are in the same broadcast domain as the filers. This option does not work with clients that are routed into the filer segment since most filer stacks will not respond to ARP requests from IP addresses that are not local to the filer subnet.

If network topology manager 715 receives a valid ARP response from the endpoint in question, the endpoint will be added to the topology map as a valid entry and the deferred IP query request will be completed with a successful response. If no response is received, the entry will time out after a few ARP attempts, and the IP query will be failed. The network stack will process the IP query callback and accept the triggering packet on success or forward the packet on IP query failure.

The network topology manager 715 continually monitors network endpoint presence by periodically ARP probing each endpoint. When the network topology manager 715 detects that an endpoint has left the network, it will call back into the network stack in order to proactively tear down flows that involve the “leaving” endpoint.

The network topology manager 715 can operate without any configuration in deployments where all clients and filers are in the same broadcast domains. If any clients are routed into the filer segment, or if the deployment involves a mufti-port LAG, network identity configuration is required to ensure correct operation and to avoid unexpected NAS protocol disruption.

Network identity configuration is performed through the user interface to the NAS cache appliance system 710. For each broadcast domain/subnet that the NAS cache appliance system 710 is deployed into, the user must assign a Network Identity IP and associated CIDR subnet/mask to be used by the Cache Appliance. Once configured, any Filers 708 that reside on the provided network subnet can be automatically detected.

As described herein, the NAS cache appliance is a fundamental element of the data storage cache system, and is implemented as a combination of a high-speed packet processor and a large cache memory. While a variety of different architectures may be used to implement the cache appliance, an example hardware implementation which may be used includes a network switch interconnect component for routing network traffic, a processor component for packet processing, a cache controller, and cache memory component for storing cached data files. One or more high-speed network switches 704, 706 provides client and filer interfaces and multiple 10 Gbps connections to the packet processing and cache controller hardware, manages data flow between the client/filer I/O ports and the packet processing and cache controller hardware, and may be optimized for network traffic where it is desirable to obtain extremely low latency. In addition, one or more processor units are included to run the core software on the device to perform node management, packet processing, cache management, and client/filer communications. Finally, a substantial cache memory is provided for storing data files, along with a cache controller that is responsible for connecting cache memory to the high-speed network switch.

FIG. 8 illustrates an example process flow 800 for managing a network topology at a standalone in-line cache appliance. The process starts (step 801), such as when a cache appliance is positioned between the storage clients and the NAS filers. In operation, the cache appliance operates to (i) intercept requests between the clients and filers, and (ii) provide read and write cache acceleration by storing and recalling frequently used information. After receiving an IP packet (e.g., NAS protocol packet for a new NAS protocol session as between client and NAS filer), the network stack at the cache appliance inspects the packet information associated with the request to obtain information for moving the packet through the system (e.g., network protocol traffic state parameters). The identified information includes the IP address of the targeted filer (step 803). The inspected information is used to identify packets that need to be processed by the cache appliance, as well as packets that are to be forwarded by the cache appliance. By snooping network protocol traffic state parameters and splicing connections between filers and clients, the cache appliance provides Open System Interconnect (OSI) transparency, thereby performing in the Ethernet network as a bump-in-the-wire.

Once identified, the network stack submits the target filer IP address to the network topology manager (step 805) which checks to see if the target filer IP address is included on the configured IP list (step 807). If so (affirmative outcome to decision 807), the cache appliance enables caching for the current protocol session (step 819). But if the target filer IP address is not included on the configured IP list (negative outcome to decision 807), the target filter IP address is checked against the network topology map (step 809) to see if it is currently managed (step 811). If so (affirmative outcome to decision 811), the cache appliance enables caching for the current protocol session (step 819). However, if the destination endpoint associated with the target filer IP address is not yet discovered (negative outcome to decision 811), the topology manager starts the endpoint discovery and validation process. To validate that the endpoint is real, an ARP request for the target filer IP address is sent to the appropriate Ethernet port (step 813), such as by the destination described by the 4-tuple from the triggering packet.

If the topology manager receives a valid ARP response from the target filter IP address in question (affirmative outcome to decision 815), the endpoint for the target filter IP address will be added to the topology map as a valid entry, the deferred IP query request will be completed with a successful response, and the cache appliance enables caching for the current protocol session (step 819). However, if no response is received, the entry will time out after a few ARP attempts and the IP query will be failed, at which point caching for the current protocol session will be disabled (step 817).

With the interconnect bus monitoring system disclosed herein for configuring and monitoring of the interconnect bus, it will be appreciated that redundant flow director deployments do not require a direct network connection between flow director appliances, resulting in fewer required network ports on flow director appliances. In addition, redundant flow director deployments do not require that any flow director appliances know of the existence/participation of other flow director appliances, thereby reducing system complexity and improving reliability of the flow director monitoring state machine. Another advantage is that redundant flow director deployments may be easily scaled to more than two flow director appliances since scaling becomes a factor limited to how many interconnect bus interfaces are present on each cache node appliance.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computer-readable medium that stores instructions for operating a cache appliance, the computer-readable medium including instructions that when executed by one or more processors, cause the one or more processors to perform operations comprising and comprising:
connecting the cache appliance in-line as between a networked file system and one or more clients of the networked file system, the cache appliance storing data corresponding to at least a segment of the networked file system;
processing requests from the one or more clients for application data provided by the networked file system; and
determining a topology of an enterprise network that includes the networked file system using the requests from the one or more clients, the topology identifying a set of network end points that comprise the enterprise network.

2. The computer-readable medium of claim 1, wherein instructions for determining the topology includes instructions for recording entries that identify the topology of the enterprise network.

3. The computer-readable medium of claim 1, wherein instructions for determining the topology includes instructions for intercepting at least one of an Address Resolution Protocol (“ARP”) request or reply from the enterprise network, and identifying a source endpoint of the ARP request or reply as an endpoint of the enterprise network.

4. The computer-readable medium of claim 1, further comprising instructions for performing operations that include:
receiving a request from a client for application data from the networked file system;
identifying an endpoint in the request;
making a determination as to whether the endpoint is known to exist on the enterprise network.

5. The computer-readable medium of claim 4, wherein instructions for making the determination as to whether the endpoint is known to exist on the enterprise network includes checking as to whether the endpoint of the request is identified by a previously recorded entry that identifies the endpoints of the topology, and if the endpoint is not identified by previously recorded entries, probing the enterprise network for the endpoint.

6. The computer-readable medium of claim 5, wherein instructions for probing the enterprise network include instructions for generating an Address Resolution Protocol (“ARP”) request from the cache appliance that specifies the endpoint.

7. The computer-readable medium of claim 1, further comprising instructions for performing operations that include:
processing the request at the appliance only if the determination is made that the endpoint exists on the enterprise network.

8. The computer-readable medium of claim 4, further comprising instructions for performing operations that include forwarding the request for processing by the networked file system if the determination is not made that the endpoint exists on the enterprise network.

9. A cache system comprising:
memory resources, including a first memory to store a set of instructions, and a cache to store data from at least a segment of a network;
processing resources to:
connect the cache system in-line as between a networked file system and one or more clients of the networked file system, the cache system storing data corresponding to at least a segment of the networked file system;
process requests from the one or more clients for application data provided by the networked file system; and
determining a topology of the enterprise network using the requests from the one or more clients, the topology identifying a set of network end points that comprise the enterprise network.

10. The cache system of claim 9, wherein the cache system includes:
multiple data servers that are interconnected by one or more internal busses, the data servers including the processing resources to determine the topology.

11. The cache system of claim 10, further comprising multiple flow directors, each flow director intercepting traffic as between the one or more clients and the networked file system.

12. The cache system of claim 9, wherein the processing resources record the topology by recording entries that identify the topology of the enterprise network.

13. The cache system of claim 9, wherein the processing resources determine the topology by intercepting at least one of an Address Resolution Protocol (“ARP”) request or reply from the enterprise network, and by identifying the source endpoint of the ARP request or reply as an endpoint of the enterprise network.

14. The cache system of claim 9, wherein the processing resources perform operations that include:
receive a request from a client for application data from the networked file system;
identify an endpoint in the request;
make a determination as to whether the endpoint is known to exist on the enterprise network.

15. The cache system of claim 14, wherein the processing resources make the determination as to whether the endpoint is known to exist on the enterprise network by checking as to whether the endpoint of the request is identified by a previously recorded entry that identifies endpoints of the topology, and if the endpoint is not identified by previously recorded entries, probing the enterprise network for the endpoint.

16. The cache system of claim 15, wherein the processing resources probe the enterprise network by generating an Address Resolution Protocol (“ARP”) request from the cache system that specifies the endpoint.

17. The cache system of claim 9, wherein the processing resources perform operations that include:
process a request at the cache system only if the determination is made that the endpoint exists on the enterprise network.

18. The cache system of claim 12, wherein the processing resources forward the request for processing by the networked file system if the determination is not made that the endpoint exists on the enterprise network.

19. A method for operating a set of appliances, the method being implemented by one or more processors and comprising:
connecting a set of appliances in-line as between one or more clients and the networked file system;
processing, at the set of appliances, requests from the one or more clients for application data provided by the networked file system;
determining, at the set of appliances a topology of the enterprise network using the requests from the one or more clients, the topology identifying a set of network end points that comprise the enterprise network.

20. The method of claim 19, further comprising:
receiving a request from a client for application data from the networked file system; and
identifying an endpoint in the request.
